(19) United States
(12) Patent Application Publication
(10) Pub. No.: US 2025/0207908 A1
(43) Pub. Date: Jun. 26, 2025

(54) OBJECT THICKNESS MEASURING APPARATUS AND METHOD

(71) Applicant: Samsung SDI Co., Ltd., Yongin-si (KR)

(72) Inventors: Joonkil Kim, Yongin-si (KR); Sunuk Hwang, Yongin-si (KR)

(73) Assignee: Samsung SDI Co., Ltd., Yongin-si (KR)

(21) Appl. No.: 18/913,285

(22) Filed: Oct. 11, 2024

(30) Foreign Application Priority Data
Dec. 21, 2023 (KR) 10-2023-0188937

(51) Int. Cl. G01B 11/06; G01B 11/14

(52) U.S. Cl. CPC G01B 11/06; G01B 11/14

(57) ABSTRACT

An object thickness measuring apparatus of the present disclosure includes: a transfer unit configured to transfer a pouch-type rechargeable battery including a sealing portion; a first scan unit configured to scan an opaque layer excluding an outermost transparent layer in the sealing portion; a second scan unit configured to scan the transparent layer in the sealing portion; and a controller configured to calculate a thickness of the sealing portion from three-dimensional data generated by collecting image data measured by the first scan unit and image data measured by the second scan unit.

### CROSS-REFERENCE TO RELATED APPLICATIONS

This present application claims priority to and the benefit under 35 U.S.C. § 119(a)-(d) of Korean Patent Application No. 10-2023-0188937, filed on Dec. 21, 2023, in the Korean Intellectual Property Office, the entire disclosure of which is incorporated herein by reference.

### FIELD

The present disclosure relates to an object thickness measuring apparatus and an object thickness measuring method.

### BACKGROUND

A rechargeable battery is a battery that can be charged and discharged, unlike a primary battery that cannot be recharged, low-capacity batteries in which one electrode assembly is packaged in a pack are used in small, portable electronic devices such as mobile phones and camcorders, and large-capacity batteries with dozens of electrode assemblies connected are widely used as a power source for driving motors such as electric scooters, hybrid cars, and electric vehicles. Rechargeable batteries are manufactured in various shapes, and among these, a pouch battery includes an electrode assembly formed by interposing an insulating separator between a positive electrode plate and a negative electrode plate, and a thin flexible pouch in which the electrode assembly is embedded. In this case, the pouch accommodates the electrode assembly in an inner space. Of course, a plurality of positive electrode tabs are coupled to the positive electrode plate of the electrode assembly, and a plurality of negative electrode tabs are coupled to the negative electrode plate. After manufacturing of such a rechargeable battery is completed, a process is performed to measure a thickness of a sealing portion, which is a remaining portion of the pouch surrounding the electrode assembly. Conventional methods of measuring the sealing portion include a thickness measurement method using a micrometer, a method of measuring a thickness by positioning a physical probe at the top and connecting a dial gauge, and a method of measuring a thickness by positioning a laser point sensor at the top and bottom and calculating a difference between each sensor value. Such conventional methods of measuring the thickness of the sealing portion are a point measurement method, and thus there is a problem in that measurement error occurs when measuring the thickness of an inclined or curved object.

### SUMMARY

The present disclosure attempts to provide an object thickness measuring apparatus and an object thickness measuring method, capable of accurately measuring a thickness of a sealing portion of a pouch.

However, the technical objects of the present disclosure are not limited to the objects mentioned above, and other technical objects not mentioned can be clearly understood by those skilled in the art from the description of the claims.

At least one embodiment of the present disclosure provide an object thickness measuring apparatus including: a transfer unit configured to transfer a pouch-type rechargeable battery including a sealing portion; a first scan unit configured to scan an opaque layer excluding an outermost transparent layer in the sealing portion; a second scan unit configured to scan the outermost transparent layer in the sealing portion; and a controller configured to calculate a thickness of the sealing portion from three-dimensional data generated by collecting image data measured by the first scan unit and image data measured by the second scan unit.

The controller may calculate a thickness of the sealing portion using Equation 1 below:

$$U = W + ( K * 2 ) \qquad [ Equation 1 ]$$

wherein U indicates an entire thickness of the sealing portion, W indicates a thickness of the entire opaque layer excluding the outermost transparent layer in the sealing portion, and K indicates a thickness of one transparent layer.

The first scan unit may include: a guide member; a support member coupled to the guide member and moved along the guide member; and two distance measuring sensors coupled to the support member, spaced apart from one another, and configured to measure a distance to an object.

The transfer unit may further include the object thickness measuring apparatus further includes a position alignment jig installed adjacent to the first scan unit and configured to align the first scan unit.

The position alignment jig may include: a pillar member; a first jig member coupled to a first side of the pillar member, and configured to have a first length and to include a target portion positioned in a central portion; a second jig member coupled to a first end of an upper surface of the first jig member and configured to have a second length that is shorter than the first length; and a third jig member coupled to a second end of a lower surface of the first jig member and configured to have the second length.

The target portion may include a specific symbol and extend through a center of the first jig member in a vertical direction.

The second scan unit may be a confocal sensor.

a photographing unit configured to photograph the pouch-type rechargeable battery to allow the transfer unit to align a position of the pouch-type rechargeable battery.

The photographing unit may include: a light irradiation member configured to irradiate light to the pouch-type rechargeable battery; a position detection member configured to detect a position of the pouch-type rechargeable battery by photographing the pouch-type rechargeable battery; and a laser module configured to irradiate a laser used to focus the position detection member toward the light irradiation member.

The controller may include: a three-dimensional data generator configured to generate three-dimensional data from image data measured by the first scan unit and the second scan unit; a division unit configured to divide the three-dimensional data into certain regions to create a unit region; a plane setting unit configured to convert (fit) the unit region of a curved shape into a planar shape, a thickness calculator configured to calculate a thickness of the sealing portion by measuring a distance in a thickness direction in the unit region; and an output unit configured to output a value calculated by the thickness calculator.

The transfer unit may include: a rail member; a first moving member positioned perpendicular to the rail member and configured to move along the rail member; a second moving member coupled to the first moving member and configured to move along the first mobile member; a holding member configured to hold the pouch-type rechargeable battery; a lifting member coupled to a first side of the holding member and configured to move the holding member in a vertical direction; and a rotating member configured to connect the elevating member and the second moving member and to rotate the elevating member in clockwise and counterclockwise directions with respect to the second moving member.

At least one embodiment of the present disclosure provides an object thickness measuring method including: a transparent layer scan operation of scanning an outermost transparent layer in a sealing portion included in a pouch-type rechargeable battery; an opaque layer scan operation of scanning an opaque layer excluding the transparent layer in the sealing portion; a three-dimensional data generating operation of generating three-dimensional data using data obtained by scanning the transparent layer and data obtained by scanning the opaque layer; and a thickness calculating operation of calculating a thickness of the sealing portion from the three-dimensional data.

The thickness calculating operation may include: a unit region generating operation of dividing the three-dimensional data into certain regions to generate a unit region; a calculating operation of calculating a thickness value of the sealing portion by converting (fitting) the curved unit region into a planar shape and measuring a distance in a thickness direction from the planar shape; and an output operation of outputting a thickness value of the sealing portion.

The thickness of the sealing portion may be calculated using Equation 1:

$$U = W + ( K * 2 ) \qquad [ equation 1 ]$$

wherein U indicates an entire thickness of the sealing portion, W indicates a thickness of the entire opaque layer excluding the outermost transparent layer in the sealing portion, and K indicates a thickness of one transparent layer.

Before the opaque layer scan operation, a position aligning operation of aligning positions of the rechargeable batteries, and a sensor aligning operation of aligning positions of two distance measuring sensors may be performed.

It may further include a model detecting operation of detecting a model of the rechargeable battery supplied in the rechargeable battery supply operation.

According to the present disclosure, an object thickness measuring apparatus includes a first scan unit and a second scan unit to measure the transparent layer and the opaque layer by scanning. A conventional method of measuring the thickness of a sealing portion measures the thickness by physically pressing a spot area, and thus an error in a measurement value occurs when measuring the thickness of a tilted or curved object. However, the object thickness measuring apparatus according to the present disclosure may generate three-dimensional data from image data of the transparent layer and the opaque layer, may convert a curved surface of the three-dimensional data into a plane, and then may accurately measure the thickness of the plane.

In addition, in the conventional method of measuring the thickness of the sealing portion, the sensors used for thickness measurement were physically adjusted and aligned, but the object thickness measuring apparatus according to the present disclosure may improve alignment precision of the distance measurement sensor by performing alignment using a software method using a position alignment jig.

In addition, the object thickness measuring apparatus according to the present disclosure may align a position of the rechargeable battery using a vision alignment method using a photographing unit, and thus in response to various types of rechargeable batteries, the thickness of the sealing portion of each rechargeable battery may be measured.

In addition, the object thickness measuring apparatus according to the present disclosure may automate the entire process of measuring the thickness of the sealing portion, allowing the thickness of the sealing portion to be quickly measured.

### BRIEF DESCRIPTION OF THE DRAWINGS

The following drawings attached to this specification illustrate preferred embodiments of the present disclosure, and together with the detailed description of the disclosure described later, serve to further understand the technical idea of the present disclosure, and thus the present disclosure should not be construed as limited to only the matters depicted in such drawings.

FIG. 1 illustrates a cross-sectional view showing an interior of a typical pouch-type secondary battery.

FIG. 2 illustrates a top plan view showing an overall layout of an object thickness measurement apparatus according to an embodiment of the present disclosure.

FIGS. 3A and 3B illustrate a drawing and graph for describing an operation of a second scan unit.

FIG. 4 illustrates a perspective view showing a first scan unit and a position alignment jig.

FIG. 5 illustrates a perspective view showing a first jig member, a second jig member, and a third jig member extracted from a position alignment jig.

FIG. 6 illustrates a side view for describing the position alignment jig of FIG. 5.

FIGS. 7A, 7B and 7C illustrate a process in which two distance measurement sensors are aligned by a position alignment jig.

FIG. 8 illustrates a perspective view showing a photographing unit and a second scanning unit.

FIG. 9 illustrates a block diagram showing a controller.

FIG. 10 illustrates a view for describing converting a unit region of a curved shape into a planar shape.

FIG. 11 illustrates a view for describing measuring a thickness of a sealing portion in a unit region of a planar shape.

FIG. 12 illustrates a perspective view showing a transfer unit.

FIG. 13 illustrates a flowchart showing an object thickness measuring method according to an embodiment of the present disclosure.

FIG. 14 illustrates a flowchart showing a thickness calculating operation.

FIG. 15 illustrates a flowchart showing an object thickness measuring method according to another embodiment of the present disclosure.

### DETAILED DESCRIPTION

Hereinafter, embodiments of the present disclosure will be described in detail with reference to the accompanying drawings. Prior to this, terms and words used in this specification and claims should not be construed as limited to their usual or dictionary meanings, and based on the principle that the inventor can appropriately define the concept of the term in order to explain his or her disclosure in the best way, it must be interpreted with a meaning and concept consistent with the technical idea of the present disclosure. Since the embodiments described in the specification and the configurations shown in the drawings are merely the most preferable some embodiment and configurations of the present disclosure, they do not represent all of the technical ideas of the present disclosure, and it should be understood that various equivalents and modified examples, which may replace the embodiments, are possible, when filing the present application.

Additionally, when used herein, “comprise, include,” and/or “comprising, including” specifies the presence of the mentioned figures, numbers, steps, actions, members, elements and/or groups of these, and does not exclude the presence or addition of one or more other shapes, numbers, operations, members, elements and/or groups.

In addition, to facilitate understanding of the disclosure, the attached drawings are not drawn to actual scale and the dimensions of some components may be exaggerated. Furthermore, the same reference numbers may be assigned to the same components in different embodiments.

Stating that two objects of comparison are ‘the same’ means that they are ‘substantially the same’. Therefore, substantially identical may include a deviation that is considered low in the art, for example, a deviation of less than 5%. Additionally, uniformity of a parameter in a certain region may mean uniformity from an average perspective.

Although the first, second, etc. are used to describe various components, it goes without saying that these components are not limited by these terms. These terms are only used to distinguish one component from another component, and unless specifically stated to the contrary, the first component may also be a second component.

Throughout the specification, unless otherwise stated, each component may be singular or plural.

Disposition of any component to the “upper (or lower) portion” of the component or to the “upper (or lower)” portion of the component may indicate that not only is an arbitrary component disposed in contact with the upper (or lower) surface of the component, but also other components may be interposed between the component and any component disposed on (or under) the component.

Additionally, if a component is described as “on,” “connected to,” or “coupled to” another component; the above components may be directly connected or connected to each other, but it should be understood that other components may be “interposed” between each component, or that each component may be “connected,” “combined,” or “connected” through other components.

As used herein, the term “and/or” includes any and all combinations of one or more of the associated listed items. Additionally, the use of “may” when describing embodiments of the present disclosure relates to “one or more embodiments of the present disclosure.”

Expressions such as “one or more” and “one or more” preceding a list of elements modify the entire list of elements and do not modify individual elements in the list.

Throughout the specification, when referring to “A and/or B”, this means A, B or A and B, unless specifically stated to the contrary, and when referring to “C to D,” this means C or higher and D or lower, unless specifically stated to the contrary.

When phrases such as “at least one selected from the group A, B and C”, “at least one selected from the group A, B or C”, “at least one selected from the group A, B and C” and “at least one selected from the group A, B and C” are used to specify a list of elements A, B and C, the phrases may refer to any and all suitable combinations.

The term “use” may be considered synonymous with the term “utilize.”

As used herein, “substantially,” “about,” and similar terms are used as terms of approximation rather than terms of degree, and are to take into account the inherent variation in measured or calculated values that a general engineer in the relevant technical field would recognize.

In this specification, although the terms first, second, third, etc. may be used to describe various elements, components, regions, layers and/or sections, these elements, components, regions, layers and/or sections should not be limited by these terms. This term is used to distinguish one element, component, region, layer, or cross-section from another element, component, region, layer, or cross-section. Accordingly, a first element, component, region, layer, or section discussed below may be named a second element, component, region, layer, or section without departing from the teachings of the example embodiments.

To illustrate the relationship of one element or feature to another element(s) or feature(s) as shown in a drawing, for ease of description, spatially relative terms such as “beneath,” “below,” “lower,” “above,” “upper,” etc. may be used herein. Spatial relative position will be understood to encompass different directions of the device in use or operation in addition to the direction depicted in the figures. For example, if the device in the drawing is turned over, elements described as “below” or “lower” other elements are understood to be “above” or “upper” other elements. Accordingly, the term “down” may encompass both upward and downward directions.

The terms used in this specification are for describing embodiments of the present disclosure and are not intended to limit the present disclosure.

Before describing an object thickness measuring apparatus according to an embodiment of the present disclosure, a general rechargeable battery will be described.

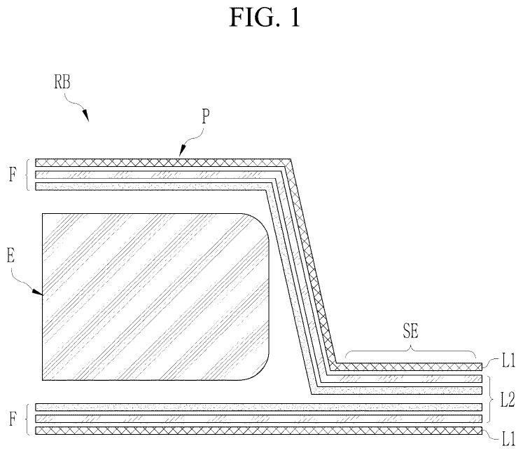

FIG. 1 illustrates a cross-sectional view showing an interior of a typical pouch-type secondary battery.

Referring to FIG. 1, a typical pouch-type rechargeable battery RB includes a pouch P and an electrode assembly E.

The pouch P includes two films (or thin films) F. A portion of the film F that does not surround the electrode assembly E is sealed. In this way, the sealed portion of the pouch P may be defined as the sealing portion SE for simplicity.

Meanwhile, the film F may be a composite film including, e.g., nylon, aluminum foil, and unstretched polypropylene (CPP: cast polypylene). Additionally, the nylon positioned on an outermost layer of the film F is a transparent layer L1, and a remaining portion is an opaque layer L2.

Hereinafter, an object thickness measuring apparatus used to measure the thickness of the sealing portion SE including the transparent layer L1 and the opaque layer L2 will be described in detail with reference to the drawings.

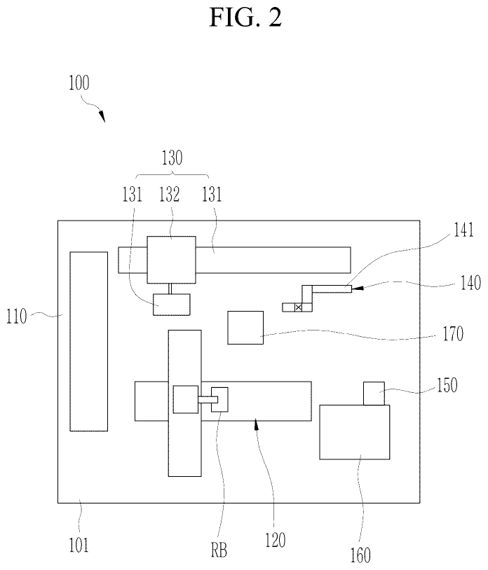

FIG. 2 illustrates a top plan view showing an overall layout of an object thickness measurement apparatus according to an embodiment of the present disclosure.

Referring to FIG. 2 and the above-described FIG. 1, the object thickness measuring device 100 according to an embodiment of the present disclosure includes a transfer unit 120, a first scan unit 130, a second scan unit 150, and a controller 170.

The transfer unit 120 transfers the pouch-type rechargeable battery RB including the sealing portion SE. Then, the transfer unit 120 aligns positions of the pouch-type rechargeable batteries RB.

The transfer unit 120 may be installed in a work space or on a stage 101. Hereinafter, for better comprehension and ease of description, the description will be limited to the transfer unit 120, first scan unit 130, second scan unit 150, and control unit 170, as well as various parts being installed on stage 101. A detailed description of the transfer unit 120 will be provided later.

Meanwhile, the object thickness measuring apparatus 100 according to an embodiment of the present disclosure may further include a supply unit 110. The supply unit 110 may supply a plurality of secondary batteries RB to the transfer unit 120.

The object thickness measuring apparatus 100 according to an embodiment of the present disclosure may measure a thickness of the sealing portion SE of one type of rechargeable battery RB, but may also measure thicknesses of the sealing portions SE of various types or multiple rechargeable batteries RB. In this case, the supply unit 110 may supply a plurality of rechargeable batteries RB to the transfer unit 120 one by one.

Although not shown in the drawing, the supply unit 110 may hold the rechargeable batteries RB one by one and discharge them to the transfer unit 120, for example. In this case, the rechargeable batteries RB may be positioned in a separate loading space or may be stored inside the supply unit 110.

The first scan unit 130 scans the opaque layer L2 excluding the outermost transparent layer L1 in the sealing portion SE. The first scan unit 130 cannot scan the transparent layer L1 made of a transparent material, but scans an outline of the opaque layer L2.

The sealing portion SE is a part where the films F that make up the pouch P are joined together, and thus appearance of the opaque layer L2 scanned by the first scan unit 130 is appearance of the opaque layer L2 when the opaque layers of the two films F are bonded together.

The image data acquired by the first scan unit 130 is relative distance data that measures a relative distance between the sealing portion SE and the opaque layer L2. A detailed description of the first scan unit 130 for this purpose will be provided later.

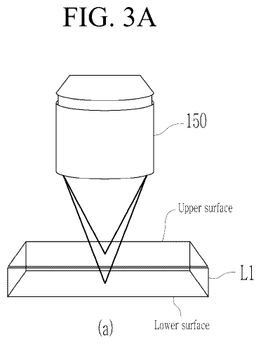

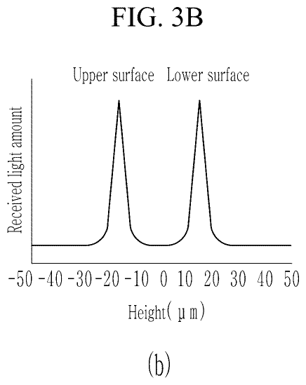

The second scan unit 150 scans the transparent layer L1 in the sealing portion SE. The second scan unit 150 may be, e.g., a confocal sensor. As illustrated in FIG. 3A, the confocal sensor may measure both relative distances with upper and lower surfaces of the transparent layer L1.

Accordingly, the second scan unit 150 may measure not only a relative distance with the transparent layer L1 of the sealing portion SE but also a thickness of the transparent layer L1. That is, the image data acquired by the second scan unit 150 may include relative distance data and thickness data for the transparent layer L1 of the sealing portion SE.

The controller 170 calculates the thickness of the sealing portion SE from three-dimensional data (3D) generated by combining the image data measured by the first scan unit 130 and the image data measured by the second scan unit 150. This controller 170 may calculate the thickness of the sealing portion SE using Equation 1 below.

$$U = W + ( K * 2 ) \qquad [ Equation 1 ]$$

Herein, U indicates the total thickness of the sealing part SE, W indicates a thickness of the entire opaque layer L2 excluding the outermost transparent layer L1 in the sealing portion SE, and K indicates the thickness of one transparent layer L1. A detailed description of the controller 170 for this purpose will be provided later.

An operation process of the object thickness measuring apparatus 100 according to an embodiment of the present disclosure as described above will be described as follows.

First, the transfer unit 120 transfers the rechargeable battery RB to the first scan unit 130. The first scan unit 130 scans the opaque layer L2 to obtain image data.

Next, the transfer unit 120 transfers the rechargeable battery RB to the second scan unit 150. The second scan unit 150 acquires image data by scanning the transparent layer L1.

Finally, the controller 170 collects the image data of the first scan unit 130 and the image data of the second scan unit 150, and calculates the thickness of the seal SE from the collected three-dimensional data (3D).

The object thickness measuring apparatus 100 according to an embodiment as described above includes a first scan unit 130 and a second scan unit 150 and measures the transparent layer L1 and the opaque layer L2 using a scan method. A conventional method of measuring the thickness of a sealing portion measures the thickness by physically pressing a spot area, and thus an error in a measurement value occurs when measuring a thickness of a tilted or curved object.

However, the object thickness measuring apparatus 100 according to the present disclosure may generate three-dimensional data (3D) from image data of the transparent layer L1 and the opaque layer L2, may convert a curved surface of the three-dimensional data (3D) into a plane, and then may accurately measure the thickness of the plane.

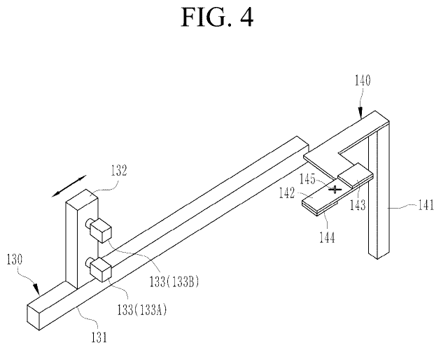

FIG. 4 illustrates a perspective view showing a first scan unit and a position alignment jig.

Referring to FIG. 4, the first scan unit 130 may include, e.g., a guide member 131, a support member 132, and two distance measurement sensors 133.

The guide member 131 may be installed on the stage 101 (see FIG. 2). The guide member 131 may be installed to cross left and right directions of the stage 101 based on a direction shown in the drawing.

The support member 132 is coupled to the guide member 131 and moves along the guide member 131. The support member 132 may have a pillar shape, e.g., and may be positioned in an upward or downward direction with respect to the guide member 131. The two distance measurement sensors 133 are coupled to the support member 132, are positioned to be spaced apart from each other, and measure a distance to an object.

One of the two distance measurement sensors 133 (133B) measures the relative distance between the distance measuring sensor 133 and the opaque layer L2 on an upper side of the sealing portion SE. Then, the remaining distance measurement sensor 133A measures the relative distance between the distance measuring sensor 133 and the opaque layer L2 on a lower side of the sealing portion SE.

The distance measurement sensor 133 for this purpose may be, e.g., a laser distance sensor that irradiates a laser to the sealing portion SE of the rechargeable battery RB (see FIG. 1), but the present disclosure is not limited thereto.

The first scan unit 130 as described above can acquire image data by measuring a relative distance between the upper and lower opaque layers L2 of the sealing portion SE using two distance measurement sensors 133.

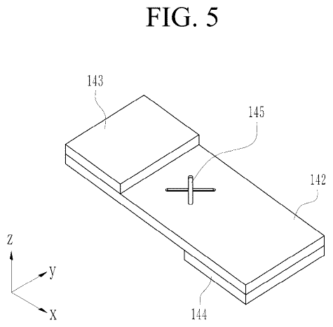

FIG. 5 illustrates a perspective view showing a first jig member, a second jig member, and a third jig member extracted from a position alignment jig,

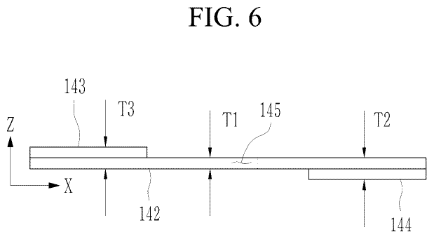

FIG. 6 illustrates a side view for describing the position alignment jig of FIG. 5, and

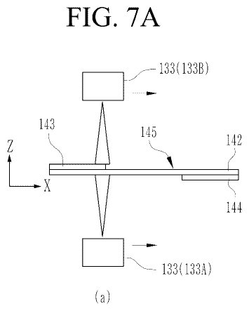

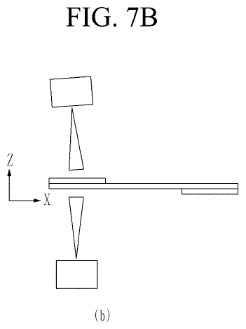

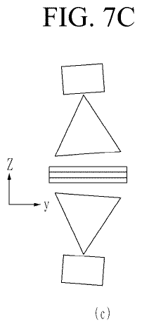

FIGS. 7A, 7B and 7C illustrate a process in which two distance measurement sensors are aligned by a position alignment jig.

Additionally referring to FIG. 4 along with FIGS. 5 to 7, the object thickness measuring apparatus 100 according to an embodiment of the present disclosure may further include a position alignment jig 140.

The position alignment jig 140 may be installed adjacent to the first scan unit 130, and may be used to align the position of the first scan unit 130. The position alignment jig 140 for this purpose may include, e.g., a column member 141, a first jig member 142, a second jig member 143, and a third jig member 144.

The pillar member 141 may be positioned in a vertical direction on the stage 101 (see FIG. 2). The pillar member 141 may be spaced apart from the first jig member 142 with respect to the stage 101. The first jig member 142 may be arranged parallel to the stage 101.

The first jig member 142 is coupled to one side of the pillar member 141 and has a first length. Additionally, a target portion 145 may be positioned in a central portion of the first jig member 142. The target portion 145 is made of a specific symbol and extends through a center of the first jig member 142 in the vertical direction. A shape of the target portion 145 may be, e.g., a shape of the alphabet X.

The two distance measurement sensors 133A and 133B of the first scan unit 130 irradiate a laser to the target unit 145, so that the two distance measurement sensors 133A and 133B may be accurately positioned on a same line in the vertical direction. For this purpose, although not shown in the figures, a driving module (not shown) that controls the position of each of the two distance measurement sensors 133A and 133B may be installed inside the first scan unit 130.

When the support member 132 moves the two distance measurement sensors 133A and 133B to the alignment jig 140, the first jig member 142 may preferably be positioned between the two distance measuring sensors 133A and 133B. To this end, a length of the pillar member 141 may be set to a length corresponding to the distance between the two distance measurement sensors 133 from the stage 101.

The second jig member 143 is coupled to one end of an upper surface of the first jig member 142 and has a second length that is relatively shorter than the first length. For example, the second length may be ⅓ of the first length.

When the first jig member 142 is divided into three parts in the length direction, the second jig member 143 may be positioned at one end of the first jig member 142, and the third jig member 144, which will be described later, may be positioned at the other end of the first jig member 142. In addition, the target portion 145 may be positioned between the second jig member 143 and the third jig member 144. A shape of the second jig member 143 may be, e.g., a square plate.

The third jig member 144 is coupled to the other end of a lower surface of the first jig member 142 and has the second length. The third jig member 144 and the second jig member 143 may have shapes and sizes that correspond to each other. A shape of the third jig member 144 may be, e.g., a square plate.

A process by which the above-described first scan unit 130 sets the positions of the two distance measurement sensors 133A and 133B by the position alignment jig 140 is described as follows. Herein, as described above, each of the two distance measurement sensors 133 may be moved and rotated in multiple directions by a separate driving module (not shown), and a detailed description thereof will be omitted.

Meanwhile, structural analysis of a specific object may be explained by constraints, and in general, constraints simulate actual physical phenomena using six degrees of freedom Tx, Ty, Tz, Rx, Ry, and Rz. The structural analysis of the two distance measuring sensors 133A and 133B can also be simulated by the six degrees of freedom Tx, Ty, Tz, Rx, Ry, and Rz, and Tx, Ty, and Tz mean displacement constraints in the x, y, and z directions, and Rx, Ry, and Rz mean rotation constraints in the x, y, and z directions.

This explains how the six degrees of freedom of the two distance measuring sensors 133A and 133B are set. As shown in FIG. 7A, the support member 132 of the first scan unit 130 moves in one direction along the guide member 131. The first jig member 142 may be positioned between the two distance measurement sensors 133A and 133B. The two distance measurement sensors 133A and 133B operate together to scan the first jig member 142, the second jig member 143, and the third jig member 144.

Each of the two distance measuring sensors 133A and 133B detects the target portion 145. In this case, each of the two distance measurement sensors 133 is positioned side by side in the vertical direction with the target portion 145, and centers of upper and lower portions may be aligned (Tx and Ty).

In addition, each of the two distance measuring sensors 133A and 133B may be rotated in the horizontal direction based on the target portion 145, and upper and lower rotation axes may be matched (Rz) using a rotation value by which the target portion 145 is relatively rotated.

In addition, the two distance measurement sensors 133A and 133B entirely scan the first jig member 142, the second jig member 143, and the third jig member 144 while moving. In this case, a distance from each of the two distance measurement sensors 133A and 133B to the first jig member 142 is matched (Tz) using a thickness T1 of the first jig member 142 (see FIG. 6).

In addition, as illustrated in FIG. 7B, the two distance measurement sensors 133A and 133B measure a degree of inclination of the first jig member 142 in the anteroposterior direction and match the inclination in the anteroposterior direction (Rx).

In addition, as illustrated in FIG. 7C, the two distance measurement sensors 133A and 133B measure a degree of tilt in left and right directions of the first jig member 142 and match the tilt in the left and right directions (Ry) while detecting a combined thickness T3 of the first jig member 142 and the second jig member 143 (see FIG. 6) and a combined thickness T2 of the first jig member 142 and the third jig member 144 (see FIG. 6).

As the above process is performed, the position of each of the two distance measurement sensors 133A and 133B may be aligned. Accordingly, each of the two distance measuring sensors 133A and 133B may accurately scan the opaque layer L2 of the sealing portion SE of the rechargeable battery RB without error.

In addition, the conventional sealing thickness measurement method aligns the sensors by physically adjusting them, but the object thickness measurement apparatus 100 (see FIG. 2) according to the present disclosure may significantly improve alignment accuracy of the distance measurement sensors 133 by performing alignment using a software method using the position alignment jig 140.

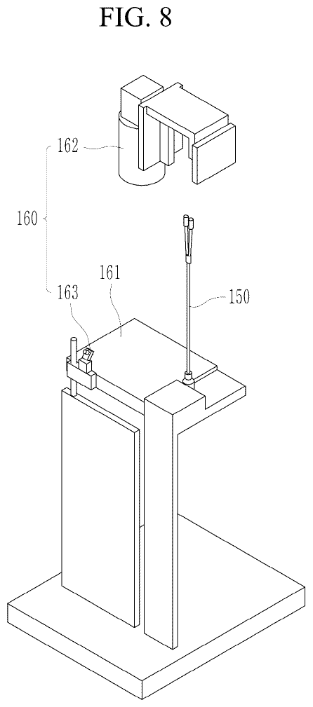

FIG. 8 illustrates a perspective view showing a photographing unit and a second scanning unit.

Referring to FIG. 8, the object thickness measuring apparatus 100 according to an embodiment of the present disclosure may further include a photographing unit 160.

The photographing unit 160 photographs the pouch-type rechargeable battery RB so that the transfer unit 120 may align the position of the pouch-type rechargeable battery RB (see FIG. 2).

For this purpose, the photographing unit 160 may include, e.g., a light irradiation member 161, a position detection member 162, and a laser module 163.

The light irradiation member 161 irradiates light to the pouch-type photographing battery RB. The light irradiation member 161 may be, e.g., a surface light source.

The position detection member 162 detects a position of the pouch-type rechargeable battery RB by photographing the pouch-type rechargeable battery RB. In order for the first scan unit 130 and the second scan unit 150 to accurately measure a thickness of the sealing portion SE, the rechargeable battery RB must be positioned at a target position.

The position detection member 162 may include, e.g., a camera and an image processor (not shown). Photographic data may be acquired by photographing an object with a camera, and an image processor may detect a position of an object from the photographic data.

If the photographing unit 160 determines that the position of the rechargeable battery RB does not match the target position, the transfer unit 120 slightly changes the position of the rechargeable battery RB. Accordingly, the rechargeable battery RB may be positioned at the target position. A detailed description of the position detection member 162 will be omitted.

The laser module 163 radiates a laser used for focusing the position detection member 162 toward the light irradiation member 161.

The object thickness measuring apparatus 100 according to an embodiment of the present disclosure uses the photographing unit 160 and the transfer unit 120 as described above to position the rechargeable battery RB at the target position using a vision alignment method. Accordingly, a thickness of the sealing portion SE of each rechargeable battery RB may be measured in response to various types of rechargeable batteries RB.

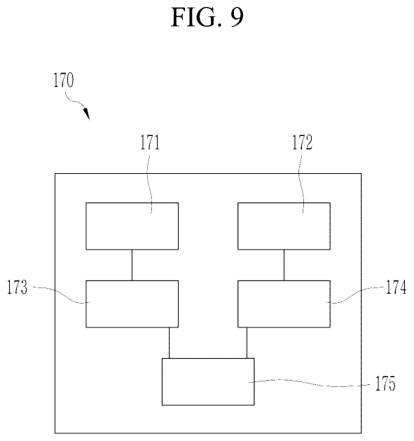

FIG. 9 illustrates a block diagram showing a controller,

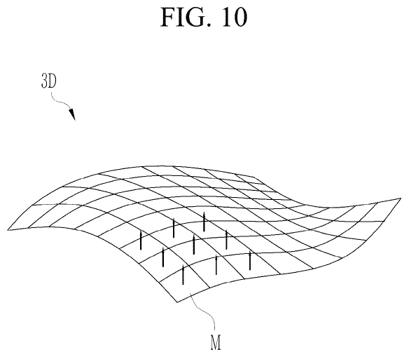

FIG. 10 illustrates a view for describing converting a unit region of a curved shape into a planar shape, and

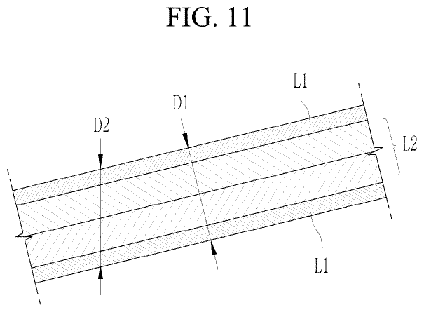

FIG. 11 illustrates a view for describing measuring a thickness of a sealing portion in a unit region of a planar shape.

Referring to FIG. 9 to FIG. 11, the controller 170 may include, e.g., a three-dimensional data generator 171, a division unit 172, a plane setting unit 173, a thickness calculator 174, and an output unit 175.

The three-dimensional data generator 171 generates three-dimensional data (3D) from image data measured by the first scan unit 130 and the second scan unit 150.

The division unit 172 divides the three-dimensional data (3D) into certain regions to generate a unit region M.

The plane setting unit 173 converts (fits) the unit region of a curved shape into a planar shape. The three-dimensional data (3D) obtained by scanning the sealing part SE may be a curved surface rather than a planar surface. It is generally difficult to accurately measure a thickness of a curved surface.

Accordingly, as shown in FIG. 10, the plane setting unit 173 may transform the unit region M into a plane so that the thickness calculator 174 may accurately measure the thickness of the three-dimensional data (3D). Herein, a detailed description of a method of developing a curved surface into a plane will be omitted.

The thickness calculator 174 calculates the thickness of the sealing portion SE by measuring a distance in the thickness direction in the unit region M. That is, the thickness calculator 174 calculates the thickness of the unit region M transformed into a plane by the plane setting unit 173. Herein, the thickness of the unit region M is the thickness of the entire sealing portion SE.

The thickness calculator 174 may calculate the entire thickness of the sealing portion SE using Equation 1 described above. The entire thickness U of the sealing portion SE (Equation 1) is calculated by adding the thickness W (Equation 1) of the entire opaque layer L2 to twice the thickness of one transparent layer L1 (Equation 1).

Meanwhile, if the controller 170 does not include the plane setting unit 173, an error may occur because the thickness calculation unit 174 measures a distance D2 (see FIG. 11) diagonally across the unit region M rather than a distance D1 (see FIG. 11) in the thickness direction of the unit region M. However, the controller 170 of the object thickness measuring device 100 according to an embodiment includes a plane setting unit 173, accurately measuring the thickness of the unit region M of a planar shape.

The output unit 175 outputs a value calculated by the thickness calculator 174. The output unit 175 may be a monitor or a printer, for example, and a detailed description thereof will be omitted.

The controller 170 as described above may calculate the thickness of the sealing portion SE from three-dimensional data (3D) generated by combining the image data measured by the first scan unit 130 and the image data measured by the second scan unit 150.

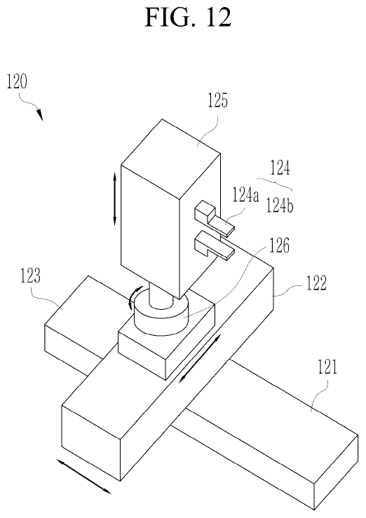

FIG. 12 illustrates a perspective view showing a transfer unit.

Referring to FIG. 12, the transfer unit 120 may include, e.g., a rail member 121, a first moving member 122, a second moving member 123, a holding member 124, an elevating member 125, and a rotating member 126.

The rail member 121 may be installed to cross left and right directions of the stage 101 (see FIG. 2) based on the direction shown in FIG. 2. The rail member 121 may be positioned parallel to the guide member 131 of the first scan unit 130.

The first moving member 122 is positioned perpendicular to the rail member 121 and moves along the rail member 121. The first moving member 122 may be a column shape.

The second moving member 123 is coupled to the first moving member 122 and moves along the first moving member 122.

The holding member 124 holds the pouch-type rechargeable battery RB. The holding member 124 may include, e.g., a first pressing pin 124a and a second pressing pin 124b. The first pressing pin 124a may press an upper surface of the rechargeable battery RB, and the second pressing pin 124b may press the lower surface of the rechargeable battery RB. The first pressure pin 124a and the second pressure pin 124b may be positioned parallel to each other in the vertical direction.

The elevating member 125 moves the holding member 124 in the vertical direction. The holding member 124 is coupled to one side of the lifting member 125.

The rotating member 126 connects the elevating member 125 and the second moving member 123. In addition, the rotation member 126 rotates the elevating member 125 in the clockwise and counterclockwise directions with respect to the second moving member 123.

The transfer unit 120 as described above may move the rechargeable battery RB (see FIG. 2) in the forward and backward directions, left and right directions, and up and down directions, and may even rotate in the left and right directions. Accordingly, the transfer unit 120 may freely transfer the rechargeable battery RB to the first scan unit 130 (see FIG. 2) or the second scan unit 150 (see FIG. 2) on the stage 101.

In addition, the transfer unit 120 may be capable of positioning the rechargeable battery RB at the target position by precisely aligning a position of the rechargeable battery RB while transferring the rechargeable battery RB to the photographing unit 160.

Hereinafter, an object thickness measuring method for measuring a thickness of a sealing portion of a rechargeable battery using an object thickness measuring apparatus according to an embodiment of the present disclosure as described above will be described with reference to the drawings.

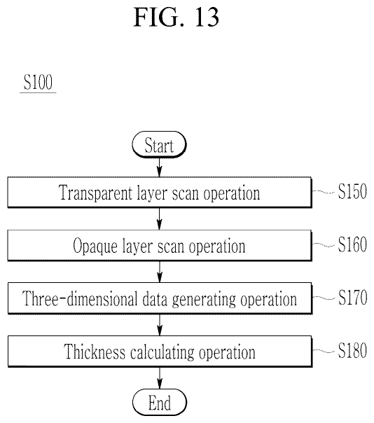

FIG. 13 illustrates a flowchart showing an object thickness measuring method according to an embodiment of the present disclosure.

Referring to FIG. 13, the object thickness measuring method (S100) according to an embodiment of the present disclosure includes a transparent layer scan operation (S150), an opaque layer scan operation (S160), a three-dimensional data generating operation (S170), and a thickness calculating operation (S180).

The transparent layer scan operation (S150) is an operation of scanning the outermost transparent layer in the sealing portion included in the pouch-type rechargeable battery. The transparent layer scan operation (S150) may be performed by the first scanning unit.

The opaque layer scan operation (S160) is an operation of scanning the opaque layer excluding the transparent layer in the sealing portion. The opaque layer scan operation (S160) may be performed by the second scanning unit.

The three-dimensional data generating operation (S170) is an operation of generating three-dimensional data using data obtained by scanning the transparent layer and data obtained by scanning the opaque layer.

The thickness calculating operation (S180) is an operation of calculating a thickness of the sealing portion from the three-dimensional data. The three-dimensional data generation operation (S170) and the thickness calculation operation (S180) may be performed by the controller.

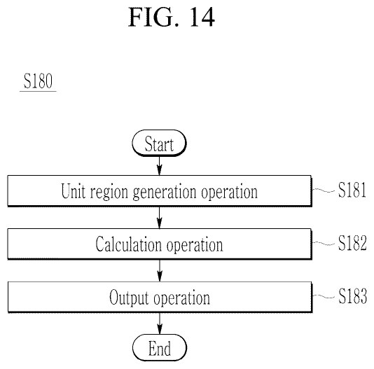

FIG. 14 illustrates a flowchart showing a thickness calculating operation.

Referring to FIG. 14, the thickness calculating operation (S180) may include, e.g., a unit region generation operation (S181), a calculation operation (S182), and an output operation (S183).

The unit region generation operation (S181) is an operation of generating a unit region by dividing the three-dimensional data into certain regions. The unit region generation operation (S181) may be performed by the above-described division unit.

The calculation operation (S182) is an operation of converting (fitting) the curved unit region into a planar shape and measuring the distance in the thickness direction from the planar shape to calculate a thickness value of the sealing portion.

The calculation operation (S182) may be performed in the plane setting unit and the thickness calculator. The thickness of the sealing portion may be calculated using Equation 1 described above. Since Equation 1 was previously described, a detailed description thereof will be omitted.

The output operation (S183) is an operation of outputting the thickness value of the sealing portion. The output operation S183 may be performed by the output unit described above.

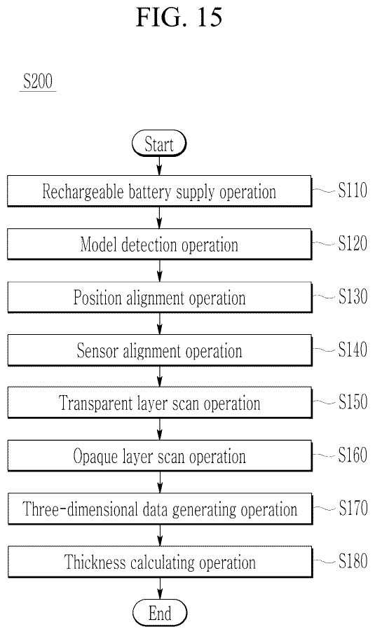

FIG. 15 illustrates a flowchart showing an object thickness measuring method according to another embodiment of the present disclosure.

Referring to FIG. 15, the object thickness measurement method (S200) according to another embodiment of the present disclosure performs a position alignment operation (S130) and a sensor alignment operation (S140) before the opaque layer scan operation (S160).

The position alignment operation (S130) is an operation of aligning positions of the rechargeable batteries. This is an operation where the position of the rechargeable battery is aligned by the above-described photographing unit and transfer unit so that the rechargeable battery is positioned at the target position.

The sensor alignment operation (S140) is an operation of aligning positions of two distance measurement sensors. The sensor alignment operation (S140) may be performed while the above-described first scanning unit scans the position alignment jig while moving relative to the position alignment jig. A detailed description of thereof has been described above, so it will be omitted.

When the sensor is already aligned, the sensor alignment operation (S140) does not need to be performed, but when the sensor is not aligned, the sensor alignment operation (S140) may be necessary.

The position alignment operation (S130) and the sensor alignment operation (S140) do not need to be performed sequentially, and it may be possible for the sensor alignment operation (S140) to be performed before the position alignment operation (S130).

In the conventional method of measuring the thickness of the sealing portion, the sensors used for thickness measurement were physically adjusted and aligned, but the object thickness measurement method (S200) according to another embodiment of the present disclosure may improve alignment precision of the distance measurement sensor by performing alignment using a software method using the sensor alignment operation (S140).

Meanwhile, the object thickness measurement method (S200) according to another embodiment of the present disclosure may further include a rechargeable battery supply operation (S110) and a model detection operation (S120).

The rechargeable battery supply operation (S110) and the model detection operation (S120) may be performed before the position alignment operation (S130) or after the position alignment operation (S130). That is, the rechargeable battery supply operation (S110) and the model detection operation (S120) can be performed independently of the position alignment operation (S130) regardless of the order.

The rechargeable battery supply operation (S110) is an operation of supplying a pouch-type rechargeable battery to the transfer unit. This rechargeable battery supply operation (S110) may be performed by the above-described supply unit, and a detailed description thereof will be omitted.

The model detection operation (S120) is an operation of detecting the model of the rechargeable battery supplied in the rechargeable battery supply operation. The model detection operation (S120) may also be performed by the above-described supply unit.

The model detection operation (S120) may be performed by an operator directly entering a model name of the rechargeable battery used to measure a thickness of an object among various rechargeable batteries into the object thickness measuring apparatus. Alternatively, the model detection operation (S120) may be performed by, as another example, a barcode reader (not shown) reading a barcode of the rechargeable battery. The barcode may be linked to model information of the rechargeable battery stored in a separate server.

Meanwhile, when measuring the thickness of the sealing portion of one type of rechargeable battery using the above-described object thickness measurement method (S100, see FIG. 13), the rechargeable battery supply operation (S110) and the model detection operation (S120) may not be performed. However, the object thickness measuring method (S200) according to another embodiment of the present disclosure may additionally perform the rechargeable battery supply operation (S110) and the model detection operation (S120) to measure the thickness of the sealing portion of various types of rechargeable batteries.

The object thickness measuring method (S100 and S200) according to the present disclosure as described above may automate the entire process of measuring the thickness of the sealing portion, allowing the thickness of the sealing portion to be quickly measured.

The object thickness measuring method (S100 and S200) according to an embodiment of the present disclosure has been described in detail while describing the object thickness measuring apparatus 100 (see FIG. 2), and thus a detailed description thereof will be omitted.

Although several embodiments of the present disclosure have been described above, while embodiments of the present disclosure have been particularly shown and described with reference to the accompanying drawings, the specific terms used herein are only for the purpose of describing the disclosure and are not intended to define the meanings thereof or be limiting of the scope of the disclosure set forth in the claims. Therefore, a person of ordinary skill in the art will understand that various modifications and other equivalent embodiments of the present disclosure are possible. Consequently, the true technical protective scope of the present disclosure must be determined based on the technical spirit of the appended claims.

<Description of Symbols>

| | |
|---|---|
| 100: object thickness measuring | 110: supply unit |
| apparatus | |
| 120: transfer unit | 121: rail member |
| 122: first moving member | 123: second moving member |
| 124: holding member | 125: elevating member |
| 126: rotating member | 130: first scan unit |
| 131: guide member | 132: support member |
| 133: distance measurement sensor | 140: position aligning jig |
| 141: pillar member | 142: first jig member |
| 143: second jig member | 144: third jig member |
| 145: target portion | 150: second scan unit |
| 160: photographing unit | 161: light irradiation member |
| 162: position detection member | 163: laser module |
| 170: controller | 171: 3-dimensional data generator |
| 172: division unit | 173: plane setting unit |
| 174: thickness calculator | 175: output unit |
| 3D: 3-dimensional data | M: unit region |
| RB: rechargeable battery | P: pouch |
| SE: sealing portion | |

What is claimed is:

1. An object thickness measuring apparatus comprising:
a transfer unit configured to transfer a pouch-type rechargeable battery including a sealing portion;
a first scan unit configured to scan an opaque layer excluding an outermost transparent layer in the sealing portion;
a second scan unit configured to scan the outermost transparent layer in the sealing portion; and
a controller configured to calculate a thickness of the sealing portion from three-dimensional data generated by collecting image data measured by the first scan unit and image data measured by the second scan unit.

2. The object thickness measuring apparatus as claimed in claim 1, wherein the controller calculates a thickness of the sealing portion using the Equation:
$$U = W + ( K * 2 )$$
wherein U indicates an entire thickness of the sealing portion, W indicates a thickness of the entire opaque layer excluding the outermost transparent layer in the sealing portion, and K indicates a thickness of one transparent layer.

3. The object thickness measuring apparatus as claimed in claim 1, wherein
the first scan unit includes:
a guide member;
a support member coupled to the guide member and configured to move along the guide member; and
two distance measuring sensors coupled to the support member, spaced apart from one another, and configured to measure a distance to an object.

4. The object thickness measuring apparatus as claimed in claim 1, wherein
the transfer unit aligns a position of the pouch-type secondary battery,
the object thickness measuring apparatus further includes a position alignment jig installed adjacent to the first scan unit and configured to align the first scan unit.

5. The object thickness measuring apparatus as claimed in claim 4, wherein
the position alignment jig includes:
a pillar member;
a first jig member coupled to a first side of the pillar member, and configured to have a first length and to include a target portion positioned in a central portion;
a second jig member coupled to a first end of an upper surface of the first jig member and configured to have a second length that is shorter than the first length; and
a third jig member coupled to a second end of a lower surface of the first jig member and configured to have approximately the second length.

6. The object thickness measuring apparatus as claimed in claim 5, wherein
the target portion includes a specific symbol and extends through a center of the first jig member in a vertical direction.

7. The object thickness measuring apparatus as claimed in claim 1, wherein
the second scan unit includes a confocal sensor.

8. The object thickness measuring apparatus as claimed in claim 1, further comprising:
a photographing unit configured to photograph the pouch-type rechargeable battery to allow the transfer unit to align a position of the pouch-type rechargeable battery.

9. The object thickness measuring apparatus as claimed in claim 8, wherein
the photographing unit includes:
a light irradiation member configured to irradiate light to the pouch-type rechargeable battery;
a position detection member configured to detect a position of the pouch-type rechargeable battery by photographing the pouch-type rechargeable battery; and
a laser module configured to irradiate a laser used to focus the position detection member toward the light irradiation member.

10. The object thickness measuring apparatus as claimed in claim 1, wherein
the controller includes:
a three-dimensional data generator configured to generate three-dimensional data from image data measured by the first scan unit and the second scan unit;
a division unit configured to divide the three-dimensional data into certain regions to create a unit region;
a plane setting unit configured to convert the unit region of a curved shape into a planar shape;
a thickness calculator configured to calculate a thickness of the sealing portion by measuring a distance in a thickness direction in the unit region; and
an output unit configured to output a value calculated by the thickness calculator.

11. The object thickness measuring apparatus as claimed in claim 1, wherein
the transfer unit includes:
a rail member;
a first moving member positioned perpendicular to the rail member and configured to move along the rail member;
a second moving member coupled to the first moving member and configured to move along the first mobile member;
a holding member configured to hold the pouch-type rechargeable battery;
a lifting member coupled to a first side of the holding member and configured to move the holding member in a vertical direction; and
a rotating member configured to connect the elevating member and the second moving member and to rotate the elevating member in clockwise and counterclockwise directions with respect to the second moving member.

12. An object thickness measuring method comprising:
a transparent layer scan operation of scanning an outermost transparent layer in a sealing portion included in a pouch-type rechargeable battery;
an opaque layer scan operation of scanning an opaque layer excluding the transparent layer in the sealing portion;
a three-dimensional data generating operation of generating three-dimensional data using data obtained by scanning the transparent layer and data obtained by scanning the opaque layer; and
a thickness calculating operation of calculating a thickness of the sealing portion from the three-dimensional data.

13. The object thickness measuring method as claimed in claim 12, wherein
the thickness calculating operation includes:
a unit region generating operation of dividing the three-dimensional data into certain regions to generate a unit region;
a calculating operation of calculating a thickness value of the sealing portion by converting (the curved unit region into a planar shape and measuring a distance in a thickness direction from the planar shape; and
an output operation of outputting a thickness value of the sealing portion.

14. The object thickness measuring method as claimed in claim 12, wherein
the thickness of the sealing portion is calculated using Equation:
$$U = W + ( K * 2 )$$
wherein U indicates an entire thickness of the sealing portion, W indicates a thickness of the entire opaque layer excluding the outermost transparent layer in the sealing portion, and K indicates a thickness of one transparent layer.

15. The object thickness measuring method as claimed in claim 12, wherein
before the opaque layer scan operation,
a position aligning operation of aligning positions of the rechargeable batteries, and
a sensor aligning operation of aligning positions of two distance measuring sensors are performed.

16. The object thickness measuring method as claimed in claim 12, further comprising:
a rechargeable battery supply operation of supplying a rechargeable battery; and
a model detecting operation of detecting a model of the rechargeable battery supplied in the rechargeable battery supply operation.
